(19) United States
(12) Patent Application Publication
(10) Pub. No.: US 2011/0292181 A1
(43) Pub. Date: Dec. 1, 2011

(54) Methods and systems using three-dimensional sensing for user interaction with applications

(75) Inventors: Sunil Acharya, San Jose, CA (US); Steve Ackroyd, San Francisco, CA (US)

(73) Assignee: CANESTA, INC.

(21) Appl. No.: 12/386,457

(22) Filed: Apr. 16, 2009

Related U.S. Application Data
(60) Provisional application No. 61/124,577, filed on Apr. 16, 2008.

(51) Int. Cl. H04N 13/02; G06K 9/40

(52) U.S. Cl. 348/47; 382/275; 348/E13.074

(57) ABSTRACT

User interaction with a device is sensed using a three-dimensional imaging system. The system preferably includes a library of user profiles and upon acquiring a three-dimensional images of a user can uniquely identify the user, and activate appliances according to user preferences in the user profile. The system can also use data from the acquired image of the user's face to confirm identity of the user, for purposes of creating a robust biometric password. Acquired three dimensional data can measure objects to provide automated, rapid and accurate measurement data, can provide image stabilization data for cameras and the like, and can create virtual three-dimensional avatars that mimic a user's movements and expressions and can participate in virtual world activities. Three-dimensional imaging enables a user to directly manipulate a modeled object in three-dimensional space.

### RELATIONSHIP TO PENDING APPLICATION

Priority is claimed from co-pending U.S. provisional patent application Ser. No. 61/124,577 filed 16 Apr. 2008, entitled METHODS AND SYSTEMS USING THREE-DIMENSIONAL SENSING FOR USER INTERACTION WITH APPLICATIONS, and assigned to Canesta, Inc., assignee herein. Said provisional patent application is incorporated herein by reference.

### FIELD OF THE INVENTION

The invention relates generally to systems and methods enabling a human user to interact with one or more applications, and more specifically to such methods and systems using three-dimensional time-of-flight (TOF) sensing to enable the user interaction.

### BACKGROUND OF THE INVENTION

It is often desirable to enable a human user to interact with an electronic device relatively transparently, e.g., without having to pick-up and use a remote control device. For example, it is known in the art to active a room light when a user walks in or out of a room. A sensor, perhaps heat or motion activated, can more or less determine when some one has entered or exited a room. The sensor can command the room light to turn on or turn off, depending upon ambient light conditions, which can also be sensed.

However it can be desirable to customize user interaction with an electronic device such that the response when one user is sensed may differ from the response when another user is sensed. In the simple example of room lighting, perhaps when the woman of the house enters a room, the lights should be on but partially dimmed, whereas when the man of the house enters the room, the lights should be fully on (or vice versa). FIG. 2 depicts a generic approach to such sensing wherein a system 5 includes one or perhaps two, red-blue-green (RGB), which may include grayscale, camera sensors 10, 10′ that sense the presence of a user 20, and control action of an appliance 30. Camera sensor 10 (or 10 and 10′ if two camera sensors are used) can try to acquire an image of user 20. Logic and memory within system 5 can then try to match the acquired image against a known image of the man or woman of the house. Based upon the acquired image and matching, appliance 30 can be commanded by system 5 to act as desired by the specific user 20.

But in real life, acquiring meaningful images from one or even two (stereographically spaced-apart) camera sensors can be difficult. For example, such cameras acquire two images whose data must somehow be correlated to arrive at a single three-dimensional image. Such stereographic data processing is accompanied by very high computational overhead. Further, such camera sensors rely upon luminosity data and can be confused, for example if a white object is imaged against a white background. Also, such camera sensors require some ambient illumination in order to function. Understandably imaging a person in a dark suit entering a darkened room in the evening can be challenging in terms of identifying the specific user, and thus knowing what response to command of appliance 30. Appliance 30 can include devices more complicated than a room light. For example appliance 30 may be an entertainment center, and when user 1 enters the room, the TV portion of the entertainment center should be turned on and tuned to the sports channel. But when user 2 enters the room, the stereo portion of the entertainment center should be turned on, and, depending upon the time of day, mood music played, perhaps from a CD library. Even more complex appliances 30 can be used, but conventional RGB or grayscale camera sensors, alone or in pairs, are often inadequate to the task of reliably sensing interaction by a user with system 5.

A more sophisticated class of camera sensor is the so-called three-dimensional system that can measure the depth Z-distance to a target object, and acquire a three-dimensional image of the target surface. Several approaches to acquiring Z or depth information are known, including approaches that use spaced-apart stereographic RGB camera sensors. However an especially accurate class of range or Z distance systems is the so-called time-of-flight (TOF) system, many of which have been pioneered by Canesta, Inc., assignee herein. Various aspects of TOF imaging systems and/or user-interfaces are described in various of the following patents assigned to Canesta, Inc.: U.S. Pat. No. 7,203,356 “Subject Segmentation and Tracking Using 3D Sensing Technology for Video Compression in Multimedia Applications”, U.S. Pat. No. 6,906,793 Methods and Devices for Charge Management for Three-Dimensional Sensing”, and U.S. Pat. No. 6,580,496 “Systems for CMOS-Compatible Three-Dimensional Image Sensing Using Quantum Efficiency Modulation”, U.S. Pat. No. 6,515,740 “Methods for CMOS-Compatible Three-Dimensional image Sensing Using Quantum Efficiency Modulation”, U.S. Pat. No. 6,323,942 (2001) “CMOS Compatible 3-D Image Sensor IC”, U.S. Pat. No. 6,614,422 (2004) “Method and Apparatus for Entering Data Using a Virtual Input Device”, and U.S. Pat. No. 6,710,770 (2004) “Quasi-Three-Dimensional Method and Apparatus to Detect and Localize Interaction of User-Object and Virtual Transfer Device”. These patents are incorporated herein by reference for a more detailed background information as to such systems, if needed. Thus although aspects of the present invention can be practiced with three-dimensional sensor systems, superior and more reliable performance characteristics are obtainable from use of three-dimensional TOF systems. Further, Canesta-type TOF systems do substantial data processing within the sensor pixels, as contrasted with the very substantially higher computational overhead associated with stereographic-type approaches. Further, Canesta-type TOF systems acquire data accurately with relatively few false positive data incidents.

FIG. 2 depicts an exemplary TOF system, as described in U.S. Pat. No. 6,323,942 entitled “CMOS-Compatible Three-Dimensional Image Sensor IC” (2001), which patent is incorporated herein by reference as further background material. TOF system 10 can be implemented on a single IC 110, without moving parts and with relatively few off-chip components. System 10 includes a two-dimensional array 130 of Z pixel detectors 140, each of which has dedicated circuitry 150 for processing detection charge output by the associated detector. In a typical application, pixel array 130 might include 100×100 pixels 140, and thus include 100×100 processing circuits 150. (Sometimes the terms pixel detector, pixel sensor, or simply pixel sensor are used interchangeably.) IC 110 preferably also includes a microprocessor or microcontroller unit 160, memory 170 (which preferably includes random access memory or RAM and read-only memory or ROM), a high speed distributable clock 180, and various computing and input/output (I/O) circuitry 190. Among other functions, controller unit 160 may perform distance to object and object velocity calculations, which may be output as DATA.

Under control of microprocessor 160, a source of optical energy 120, typically IR or NIR wavelengths, is periodically energized and emits optical energy S₁ via lens 125 toward an object target 20. Typically the optical energy is light, for example emitted by a laser diode or LED device 120. Some of the emitted optical energy will be reflected off the surface of target object 20 as reflected energy S₂. This reflected energy passes through an aperture field stop and lens, collectively 135, and will fall upon two-dimensional array 130 of pixel detectors 140 where a depth or Z image is formed. In some implementations, each imaging pixel detector 140 captures time-of-flight (TOF) required for optical energy transmitted by emitter 120 to reach target object 20 and be reflected back for detection by two-dimensional sensor array 130. Using this TOF information, distances Z can be determined as part of the DATA signal that can be output elsewhere, as needed.

Emitted optical energy Si traversing to more distant surface regions of target object 20, e.g., Z3, before being reflected back toward system 100 will define a longer time-of-flight than radiation falling upon and being reflected from a nearer surface portion of the target object (or a closer target object), e.g., at distance Z1. For example the time-of-flight for optical energy to traverse the roundtrip path noted at t1 is given by t1=2·Z1/C, where C is velocity of light. TOF sensor system 10 can acquire three-dimensional images of a target object in real time, simultaneously acquiring both luminosity data (e.g., signal brightness amplitude) and true TOF distance (Z) measurements of a target object or scene. Most of the Z pixel detectors in Canesta-type TOF systems have additive signal properties in that each individual pixel acquires vector data in the form of luminosity information and also in the form of Z distance information.

Another class of depth systems is the so-called phase-sensing TOF system, in which a signal additive characteristic exists. Canesta, Inc. phase-type TOF systems determine depth and construct a depth image by examining relative phase shift between the transmitted light signals Si having a known phase, and signals S2 reflected from the target object. Exemplary such phase-type TOF systems are described in several U.S. patents assigned to Canesta, Inc., assignee herein, including U.S. Pat. No. 6,515,740 “Methods for CMOS-Compatible Three-Dimensional Imaging Sensing Using Quantum Efficiency Modulation”, U.S. Pat. No. 6,906,793 entitled Methods and Devices for Charge Management for Three Dimensional Sensing, U.S. Pat. No. 6,678,039 “Method and System to Enhance Dynamic Range Conversion Useable With CMOS Three-Dimensional Imaging”, U.S. Pat. No. 6,587,186 “CMOS-Compatible Three-Dimensional Image Sensing Using Reduced Peak Energy”, U.S. Pat. No. 6,580,496 “Systems for CMOS-Compatible Three-Dimensional Image Sensing Using Quantum Efficiency Modulation”. Exemplary detector structures useful for TOF systems are described in U.S. Pat. No. 7,352,454 entitled “Methods and Devices for Improved Charge Management for Three-Dimensional and Color Sensing”.

FIG. 3A is based upon above-noted U.S. Pat. No. 6,906,793 and depicts an exemplary phase-type TOF system in which phase shift between emitted and detected signals, respectively, S₁ and S₂ provides a measure of distance Z to target object 20. Under control of microprocessor 160, optical energy source 120 is periodically energized by an exciter 115, and emits output modulated optical energy S₁=Sₒᵤₜ=cos(ωt) having a known phase towards object target 20. Emitter 120 preferably is at least one LED or laser diode(s) emitting low power (e.g., perhaps 1 W) periodic waveform, producing optical energy emissions of known frequency (perhaps a few dozen MHz) for a time period known as the shutter time (perhaps 10 ms).

Some of the emitted optical energy (denoted Sₒᵤₜ) will be reflected (denoted S₂=Sᵢₙ) off the surface of target object 20, and will pass through aperture field stop and lens, collectively 135, and will fall upon two-dimensional array 130 of pixel or photodetectors 140. When reflected optical energy Sᵢₙ impinges upon photodetectors 140 in pixel array 130, photons within the photodetectors are released, and converted into tiny amounts of detection current. For ease of explanation, incoming optical energy may be modeled as Sᵢₙ=A·cos(ω·t+θ), where A is a brightness or intensity coefficient, ω·t represents the periodic modulation frequency, and θ is phase shift. As distance Z changes, phase shift θ changes, and FIGS. 3B and 3C depict a phase shift θ between emitted and detected signals, S₁, S₂. The phase shift θ data can be processed to yield desired Z depth information. Within array 130, pixel detection current can be integrated to accumulate a meaningful detection signal, used to form a depth image. In this fashion, TOF system 100 can capture and provide Z depth information at each pixel detector 140 in sensor array 130 for each frame of acquired data. Pixel detection information preferably is captured at at least two discrete phases, preferably 0° and 90°, and is processed to yield Z data.

System 100 yields a phase shift θ at distance Z due to time-of-flight given by:

θ=2·ω·Z/C=2·(2·π·f)·Z/C (1)

where C is the speed of light, 300,000 Km/sec. From equation (1) above it follows that distance Z is given by:

Z=θ·C/2·ω=θ·Ċ/(2·2·f·π) (2)

And when θ=2·π, the aliasing interval range associated with modulation frequency f is given as:

Z_{AIR}=C/(2·f) (3)

In practice, changes in Z produce change in phase shift θ although eventually the phase shift begins to repeat, e.g., θ=θ+2·π, etc. Thus, distance Z is known modulo 2·π·C/2·ω)=C/2·f, where f is the modulation frequency.

Three-dimensional TOF systems such as exemplified by FIG. 2 or FIG. 3A lend themselves well to the present invention because the acquired images accurately reflect the depth of the user or other target object 20. The system does not rely upon colors, or even upon ambient light, and thus has no difficulty discerning a white object before a white background, a dark object before a dark background, even if there is no ambient light.

Thus there is a need for an improved system enabling user interaction with one or more applications or appliances. Such system should be robust in terms of operating reliably under conditions that tend to be problematic with conventional prior art approaches. Such system should enable complex control over at least one application or appliance including, without limitation, operation of home lighting, entertainment system, electronic answering machine including email server. Further such system should enable a user to track his or her food consumption including estimate caloric intake, and to track and monitor quality of daily exercise. In some applications it is useful to use the system to improve or stabilize the image acquired by a companion RGB camera. Other applications include a simple form of background substitution using depth and RGB data. In a scanning mode, the system could be used to scan a room, perhaps for use of the acquired image in a virtual environment. Other uses for such a system include monitoring of user viewing habits, including viewing of commercials and monitoring number of viewers of pay-for-viewing motion pictures or participants in pay-for-play Internet type video games. Still further applications include facial mood recognition and user gesture control for appliances.

The present invention provides such systems, and methods for implement such systems.

### SUMMARY OF THE INVENTION

User interaction with a range of applications and/or devices is facilitated in several embodiments by acquiring three-dimensional depth images of the user. Preferably these depth images are acquired with a time-of-flight (TOF) system, although non-TOF systems could instead be used.

Within a family or work group, user profiles are generated and stored within the system. As a user comes within a room space within the imaging field of view, the acquired depth images and stored user profiles enable unique identification of that user. In some embodiments, as a recognized user enters a space, the system can audibly enunciate a greeting such as “hello, Mary” to that user. The system can then adjust appliances in or about the room having environmental parameters such as lighting, room temperature, room humidity, etc. according to a pre-stored profile for that user, which profile can vary with time of day and day of week. If that user's profile so indicates, the system can activate an entertainment center and begin to play video or music according to the user's stored preferences. If the profile so indicates, the system can turn on a computer for the user. If the user leaves the work space and another use enters, the present invention can then accommodate the second user. If subsequently the first user returns, the system can optionally automatically return to the same video or audio program that was active when the user last exited the work space, and can commence precisely at the media position that was last active for this user.

Aspects of the invention enable tracking information such as user activity during playing of commercials on television. The system can identify individual users and can log for example whether female users left the room during certain commercials. The TV broadcaster can then learn that such commercials might best be omitted during broadcasts intended primarily for a female audience. Further embodiments of the present invention can determine when a child enters the entertainment room and instantly halt a television broadcast known to the system to be unsuitable for a young child. Such information can be input to the system a priori, for example from on-line broadcast listing information databases.

Acquisition of three-dimensional depth images enables the present invention to use facial characteristics of individual users as biometric password equivalents. Thus, a user's phone messages can be access-protected by requiring a would be listener to the messages to first be identified by a depth image facial scan, made by the present invention. In other embodiments, three-dimensional depth scan images can be used to track individual user's food and calorie intake, exercise regimes, and exercise performance. Embodiments of the present invention can uniquely recognize users and automatically adjust exercise equipment settings according to user profile information.

Other embodiments use three-dimensional depth images to measure, without contact, dimensions of objects including humans and rooms. Human object dimensions enable customized clothing, including shoes and boots, to be manufactured from automatically obtained accurate measurements of the user, taken in three-dimensions. Room dimensions can be acquired for purposes of construction and room improvement, estimating paint or wallpaper, etc., and for purposes of virtually resealing the room and furniture within, e.g., for architectural or interior design purposes.

Other embodiments dispose a three-dimensional imaging system within a device having its own RGB image acquisition, a camera or camera-equipped mobile telephone, for example. The depth image that is acquired can be used to electronically stabilize or dejitter an RGB image, for example an RGB image acquired by a non-stationary camera. In another embodiment, the depth image can be used to electronically subtract out undesired background imagery from a foreground image. The results are similar to so-called blue or green screen techniques used in television and film studios. If desired, the subtracted-out background image can be replaced with a solid color or a pre-stored image, suitable for background purposes. In yet another embodiment, a three-dimensional depth system is disposed within a cell telephone type device whose display can be used to play a video game. User tilting of the cell telephone can be sensed by examining changes in the acquired depth image. The result is quasi-haptisic control over what is displayed on the camera screen, without recourse to mechanical sensing mechanisms.

Other aspects of the present invention enable a user to directly manipulate in three-dimensions virtual objects, perhaps strands of DNA, molecules, a child's building blocks. In yet another aspect, the present invention can use acquired three-dimensional image data of users, and digitize this data to produce three-dimensional virtual puppet-like avatars whose movements, as seen on a display, can mimic the user's real-time movements. Further, the facial expressions on the avatars can mimic the user's real-time facial expressions. These virtual three-dimensional avatars may be used to engage in video games, in virtual world activities such as Second Life, locally or at distances via network or Internet connections, with avatars representing other users.

Other features and advantages of the invention will appear from the following description in which the preferred embodiments have been set forth in detail, in conjunction with the accompany drawings.

### BRIEF DESCRIPTION OF THE DRAWINGS

FIG. 1 depicts a generic RGB/gray scale imaging system used with an appliance, according to the prior art;

FIG. 2 depicts a time-of-flight (TOF) range finding system, according to the prior art;

FIG. 3A depicts a phase-based TOF range finding system whose Z-pixels exhibit additive signal properties, according to the prior art;

FIGS. 3B and 3C depict phase-shifted signals associated with the TOF range finding system of FIG. 3A, according to the prior art; FIG. 3A depicts spatial impulse response data collection with a TOF system, according to embodiments of the present invention;

FIG. 4 depicts an exemplary system including three-dimensional (or at least quasi-three-dimensional) sensing to enable user interaction with applications, according to embodiments of the present invention;

FIG. 5A depicts an exemplary system to monitor and record user caloric intake, according to an embodiment of the present invention;

FIG. 5B depicts an exemplary system to monitor and record user physical activity, according to an embodiment of the present invention;

FIG. 6A depicts an exemplary system used to acquire three-dimensional metric data without contacting the object being measured, according to embodiments of the present invention;

FIG. 6B depicts an embodiment in which three-dimensional metric data of an object such as a room, and objects within, in a building is measured, according to embodiments of the present invention;

FIG. 7 depicts an exemplary system fabricated within a device to enhance images captured by the device, according to embodiments of the present invention;

FIG. 8 depict user manipulation of virtual objects in three dimensions, according to embodiments of the present invention; and

FIG. 9 depicts motion capture and networkable presentation of three-dimensional cartoon-like avatars that mimic facial and other characteristics of users and may be used for conferencing, game playing, among other applications, according to embodiments of the present invention.

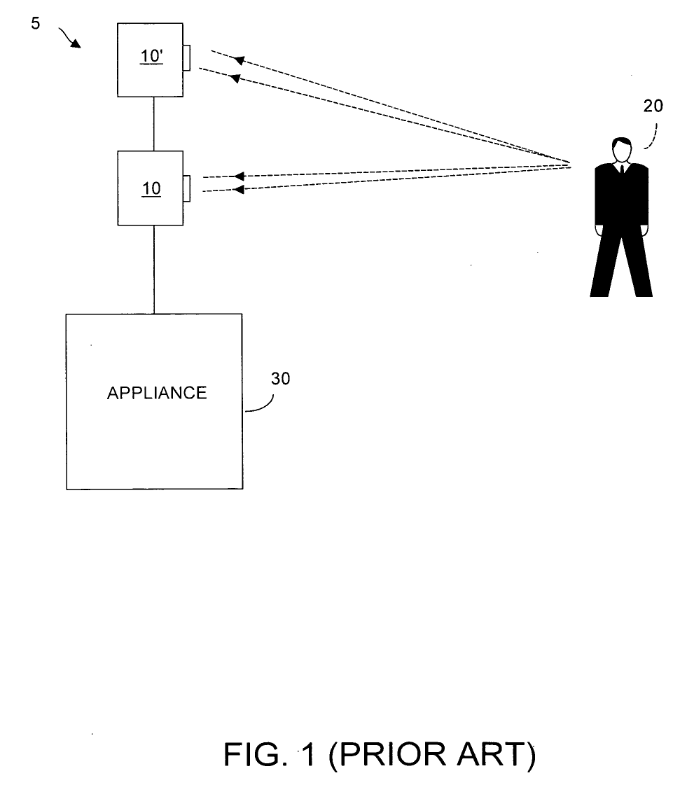

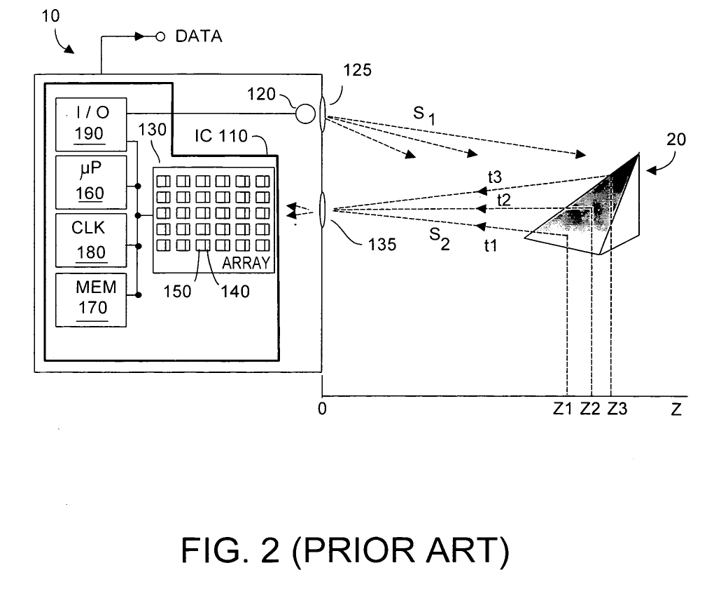

### DETAILED DESCRIPTION OF THE PREFERRED EMBODIMENTS

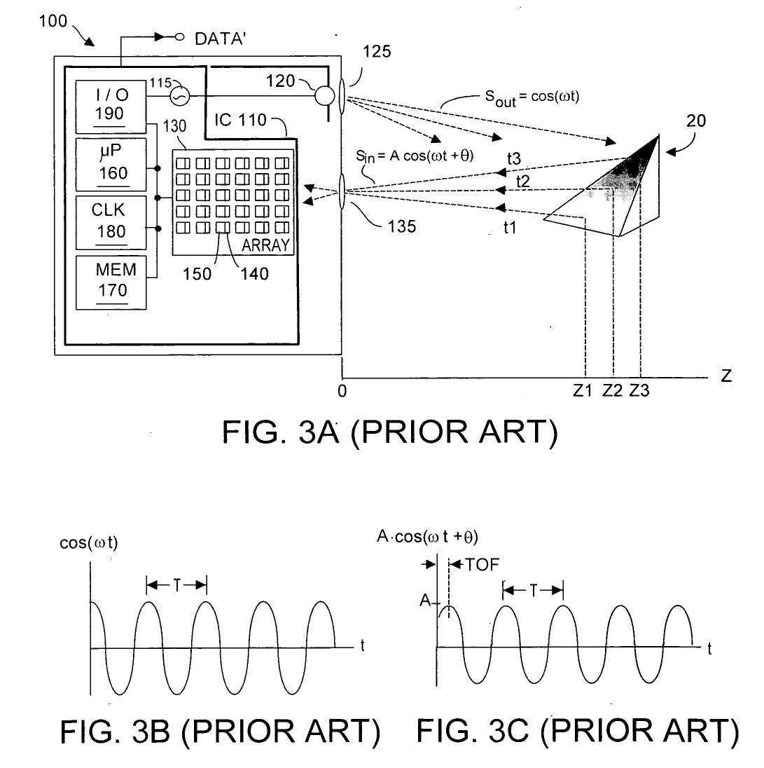

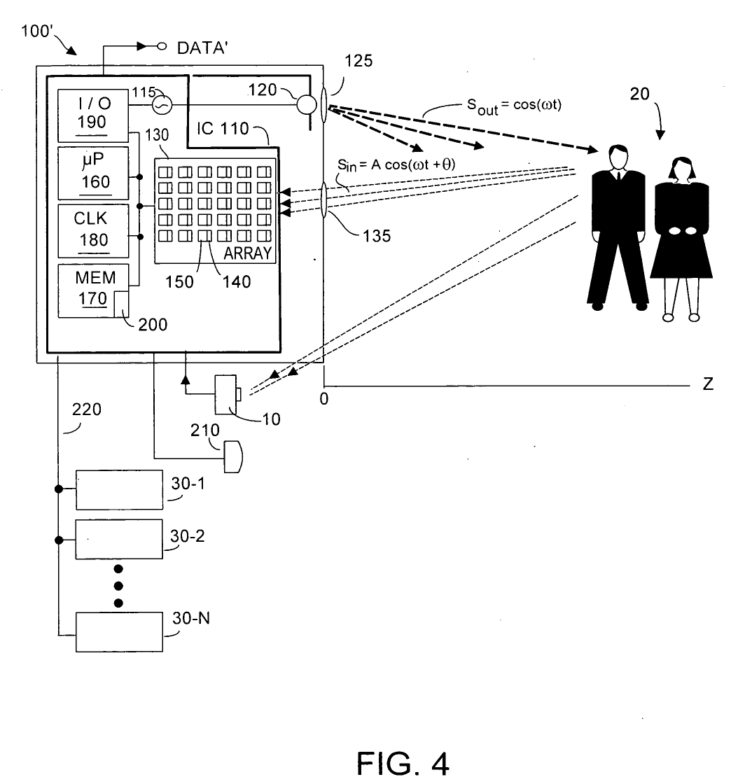

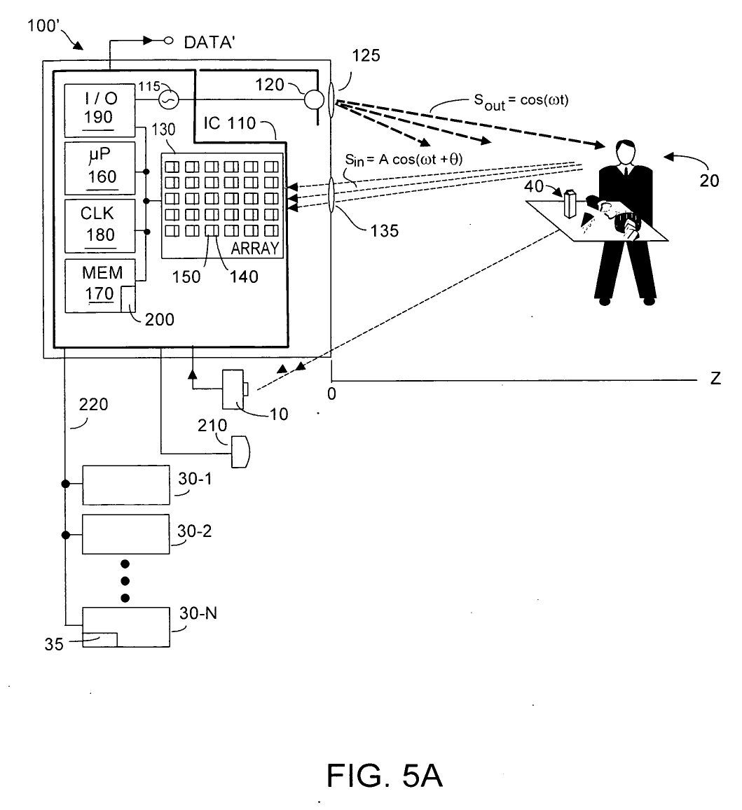

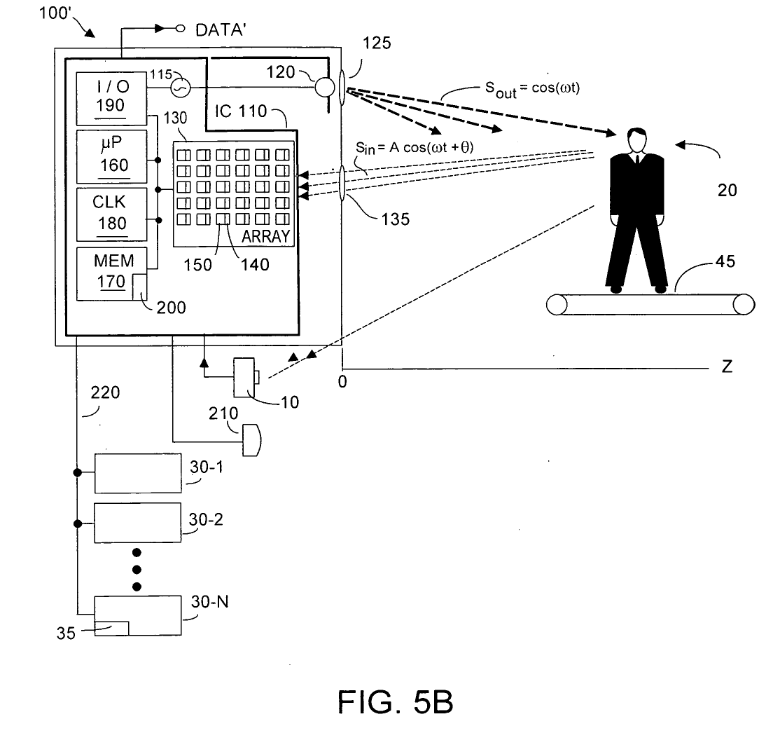

FIG. 4 depicts a three-dimensional system 100′ used to enable interaction by at least one user.20 with one or more appliances or devices, depicted as 30-1, 30-2, . . . , 30-N, in addition to enabling recognition of specific users. In some embodiments, an RGB or grayscale camera sensor 10 may also be included in system 100′. Reference numerals in FIG. 4 that are the same as reference numerals in FIG. 3A may be understood to refer to the same or substantially identically functions or components. Although FIG. 4 will be described with respect to use of a three-dimensional TOF system 100′, it is understood that any other type three-dimensional system may instead be used and that the reference numeral 100′ can encompass such other, non-TOF, three-dimensional imaging system types.

In FIG. 4, TOF system 1Q0′ includes memory 170 in which is stored or storable software routine 200 that upon execution can carry out functions according to embodiments of the present invention. Routine 200 may be executable by processor 160 or by a processor external to IC 110. The TOF system per se can be quite compact, e.g., small enough to be held in one hand in many embodiments.

With reference to FIG. 4, assume that a user 20 is entering a room at home, the living room perhaps, or perhaps a work space. TOF system 100′ can be left turned on at all times, or may be activated by a motion sensor or the like 210, to conserve operating power. Indeed system 100′ can be understood to include a time-of-day clock and optionally include a mechanism for turning itself on and off at predetermined hours. TOF system 100′ can image user 20 substantially without regard to ambient light conditions. Software 200 can compare the acquired three-dimensional depth image (represented schematically as DATA′) against a pre-stored library of user images, e.g., perhaps the man of the house, the woman of the house, each child, etc.

Preferably memory 200 stores sufficient data characteristics to uniquely profile one user from several potential users. When system 100′ is initially set up, various potential users, perhaps each family member, can be imaged three-dimensionally, including stature, and facial characteristics imaging, using system 100′. In general, facial recognition will require perhaps 360×240 pixel resolution for array 130, whereas simply discerning approximate gross size of a user might only require half that pixel density.

In addition to physical data, for each user memory 200 can store a variety of parameters including, for example, audible greetings to be enunciated, optionally, to each user, e.g., “Good morning, Mary”, “Good afternoon, Fred”, etc. Additional user parameters might include favorite TV channels versus time and day of week, preferred TV or stereo volume settings (e.g., for a hard of hearing user, system 100′ will have stored information advising to use a higher volume setting than normal). Pre-stored user profile data could also include CD selections as a function of time of day and day of week, on a per user basis. Other pre-stored data might include user's PC computer profile, where one of the controllable appliances 30-x is a computer system. Thus, by way of example if a user Mary walks into the room imaged by a system 100′, the system could give a personalized welcome, perhaps saying in the recorded voice of a loved one, “Hello, Mary”, and then adjust the room lights to a predetermined profile for the present time of date, and then turn on the stereo and begin to play a CD or other media according to Mary's profile. Within the space seen by system 100′, e.g., within the system field of view, appliances to be controlled can have parameters including lighting, room temperature, room humidity, background sound, etc. Without limitation, controllable appliances could further include a coffee or tea machine that is commanded by system 100′ to turn on and brew a beverage for the specific user, according to the user's pre-stored profile within memory 200.

To further continue the above example, assume that the relevant profile for user Mary at this time of this day requires that the room lighting (appliance 30-1) to be turned on at 50% of full illumination, and that the television set (appliance 30-2) be turned on and tuned to channel 107 with volume at 60% maximum. Having recognized from the acquired three-dimensional image that there is a user in the room and the user is Mary, software 200 will issues the appropriate commands to appliances 30-1, 30-2. For ease of illustration, a single command bus 220 is shown coupling system 100′ to the appliances. In practice such coupling could be wireless, e.g., via IR, via RF, etc., and/or via more than a single bus. Sub-commands such as channel number and volume level are issued from software 200, for example in format similar to user 20 actually holding a manipulating a remote control device to command channel selection and volume level. In such fashion, embodiments of the present invention can transparently customize some or all of a living or work space to individual users.

As noted, preferably each user will have stored in memory 200 within system 100′ a user profile indicating various preferences including optionally preferences that can be different as a function of time of day, day of week. These user profiles containing the preference can be input to system 100′ in several ways, including without limitation coupling memory 200 to a computer with a menu enabling input of user profile parameters. Such input/output (I/O) functions may be part of unit 190 in FIG. 4.

In the above example, assume that Mary is viewing a show on the TV that a child should not view, and further assume that a child now enters the TV viewing room. System 100′ will acquire a three-dimensional image of this new potential user. Upon execution, software 200 compares the just acquired image of the child to pre-stored physical data for each potential user and discerns that the potential new user is Mary's young son George, or in any event is a child, by virtue of its small stature. Among other data stored in memory 200 for the child George will be an instruction that this user may not view video below a certain rating level. (System 100′ can have available to it a dynamic list of various TV shows and ratings, listed by channel number and time of date and week.) Thus, system 100′ may realize even before Mary realizes that the TV show or media now displayed on 30-2 must be blanked out or otherwise visually and audibly muted because a young child has entered the room. Alternatively instructions in memory 200 can command the TV appliance to instantly default to a “safe” channel or media, viewable by all ages. System 100′ is sophisticated enough to halt the playing of media when a user leaves the room, to remember where in the media the halt occurred, and to then optionally restart the same media from the halt time, when the same user reenters the room.

In general, because system 100′ knows the current date and time, and can discern the identity of a user, system 100′ will know from a pre-stored profile for this user what appliances are to be activated (or deactivated) at this time, and in what manner. Suppose Mary's profile provides that if she does not want to view the current channel selection, she may wish to see a second channel selection, or perhaps hear specific music from a CD collection perhaps played through stereo appliance 30-3. System 100′ can enable Mary to communicate using gestures that are recognized by the acquired three-dimensional images. These gestures can enable a user to control an appliance 30-x in much the same fashion as though a remote control device for that appliance was being manipulated by the user. According to embodiments of the present invention, the user's body or hand(s) may be moved in pre-determined fashion to make control gestures. For example, up or down hand movement can be used as a gesture to command increase or decrease volume of an audio or TV appliance 30-x. The hand(s) may move right or left to increase or decrease channel number, with perhaps speed of movement causing channels to change more rapidly. A gesture of hand(s) moving toward or away from appliance 30 may serve as a zoom signal for the next gesture, e.g., change channels very rapidly.

In these embodiments, memory 200 preferably includes a library of allowable user gestures that are compared to an acquired image of the user making what is believed to be a gesture. Understandably, such gestures preferably are defined to exclude normal user conduct, e.g., scratching the user's head may occur normally and should not be defined as a gesture. Those skilled in the art will appreciate the difficulty associated with recognizing gestures using a non-TOF type system. Gesture recognition with a single RGB camera, e.g., camera 10, is highly dependent on adequacy of ambient lighting, color of the user's hands vis-á-vis ambient color, etc. Even use of spaced-apart stereographic RGB cameras can suffer from some of the same inadequacies.

System 100′ can conserve operating power by shutting down appliances and its own system when all users (humans) have left the room in question. The lack of human occupants is readily discernable from system examination of acquired three-dimensional images. If no humans appear in the images, as determined by software 200, system 100′ can shut down appliances, preferably according to a desired protocol stored in memory 200. Further, system 100′ can shut down itself after a time interval that can be pre-stored in memory 200 a priori. Of course system 100′ can be operated 24 hours/day as a security measure and can archive a video record of activity within the field of view of the system. While optional RGB camera 10 could also be operated 24 hours/day to archive a video record, understandably camera 10 requires ambient light and would capture little or nothing should intruders enter the room within the system field of view at night. Further, system 100′ could also be used to automatically telephone the police with a prerecorded message, e.g., “potential intruders entering home at 107 Elm Street”.

In the above example, if Mary's husband John entered the room instead of Mary, John's pre-stored profile might have commanded the room lights to be turned on to a different level of intensity, and perhaps would have commanded that a PC appliance 30-x be turned on. Possibly John's profile would have included a musical selection that differed from what Mary's profile would have called for, including a different level of volume, and perhaps a different bass boost characteristic setting for the stereo appliance. Understandably there are many permutations possible, but it will be seen that embodiments of the present invention enable user-customized responses to occur automatically and transparently to the user when a user comes within a room space that is monitored by system 100′, or perhaps more than one such system.

In FIG. 4, application 30-x might be a TIVO™-type appliance or the like that can record TV shows for a first user 20, who may watch a portion of a replay and then stop the viewing. A second user might then record another TV show and perhaps replay a portion. Later it would be desirable when user the first user activates the TV, that system 100′ automatically recognize the return of this user and then automatically cause device 30-x to resume viewing of the replay at the precise portion of the show where replay was interrupted by this user. The ability of three-dimensional imaging system 100′ to uniquely recognize users, e.g., by facial if not other characteristics, allows interrupting and automatically resuming media play on a per user basis.

Advertisers spend a great deal of money attempting to learn who actually view which of their ads. TV advertisements are somewhat monitored by Nielson viewers, who represent a small sample of the overall TV audience in the US. In FIG. 4 assume that user(s) 20 are viewing TV appliance 30-2. In one embodiment, the present invention uses system 100′ to acquire depth data as to number and type of TV viewer-users watching TV appliance 30-x at any given time. The resultant data can be off-loaded into PC 30-4 or the like, and communicated to the TV advertising industry, e.g., wirelessly, via the Internet, etc.

In such embodiment, system 100′ can count and quantify as adult or child, male or female user(s) 20 who are the audience before TV appliance 30-2, and the time duration each user was viewing the TV. Thus at any time TV 30-2 is on, the selected channel is known to system 100′, and the TV industry would know what shows and what commercial advertisements were playing at any given time. For each commercial at each time on each channel, system 100′ can record how many male users, how many female users, how many child users were viewing the TV and potentially watching each advertisement, and viewing duration per user. Thus the data acquired by system 100′ enables advertisers to obtain a more accurate sample comprising virtually all TVs in the US as to who potentially views what commercials, when. Further, if system 100′ determines that at present only females are viewing TV 30-2 then using a TIVO™ type appliance or otherwise, at the commercial break, commercials intended for females might be shown, e.g., perhaps female clothing rather than beer ads.

The ability to dynamically tailor ads to specific identifiable audiences is a potentially valuable tool for advertisers and is readily implemented by this embodiment of the present invention. In addition, the above-described embodiment is useful in a play-for-pay scenario where payment is a function of number of viewers, or if a video game, the number of player participants. One could literally build system 100′ into the TV or viewing appliance, and the number of users (viewers) within the field of view of system 100′ would be determinable and reportable to the provider of the play-for-pay media. Further, assume that systems 100′ determine statistically over a large number of users in many households or other viewing area certain types of viewers, females perhaps, walked away from the TV at a given point in a film. This valuable information could be communicated to the program director as an educational tool, and could result in a more successful future film, perhaps one that downplays the scene activity that appeared to drive away a large number of viewers. This type of information is not automatically readily available in the prior art.

Assume now that one of the appliances 30-x in FIG. 4 is an answering machine, or similar device that can gather messages or other information for one or more users. In practice it can be difficult to implement a user identification interface that ensures messages or other information intended for user 20 cannot be played or communicated to another person. User 20's password may be lost or compromised, and biometric identification for message access does not always work reliably and can be expensive to implement or maintain. In one aspect of the present invention, system 100′ acquires a three-dimensional facial image of each user intended to have access to answering machine 30-x. It should be understood that such an image cannot readily be falsified in that the depth data presents a topographically type image. Plastic surgery to make user 21 look exactly like user 20 will not enable user 21 to access user 20's messages because the physical dimensions of user 21's face will not be identical to the physical dimensions of user 20's face. Indeed it is believed that the depth image of a first identical twin would differ sufficiently from the depth image of the second identical twin to deny access to answering machine 30-x. In a sense, such use of depth data represents what might be termed a digital signature that is not readily, if at all, forged. It is understood that biometric identification protection can also be applied to systems other than an answering machine, for example, to biometrically password protect access to a user's computer or computer account, access to a user's files on a computer including, for example, access to a user's financial data.

Turning now to the embodiment of FIG. 5A, many health conscious users 20 attempt to monitor their intake of food 40, both volumetrically and quantitatively. Yet having to remember to write down how much of what food was consumed each time is sufficiently challenging as to be ignored by many individuals. Thus in FIG. 5A, system 100′ images and identifies both user 20 and the volume and type of food consumed within the field of view of the system. The user will initially have scanned typically consumed foodstuffs into system 100′ memory 200 along with calories per unit, e.g., so many calories for a quart container of milk, so many calories for an entire chocolate cake, etc. Thus automatically and transparently to user 20, system 100′ thereafter can capture food intake on a per user basis, and can log into memory 200 estimated caloric intake per user per meal.

Thus if the user consumes an estimated 30% of a cake, that approximate volume can be estimated from the three-dimensional image acquired by system 100′, and the approximate number of actual calories consumed estimated and added to that user's total for the meal in question. In this manner, a time-stamped log is maintained,, e.g., in system memory 200, and can be offloaded to a computer appliances 30-2 for subsequent consideration by the user, and perhaps the user's nutritionist or health advisor.

While FIG. 5A depicts but a few exemplary foods 40, in practice all foods commonly consumed by a user can be input into system 100′ (along with caloric data) including, without limitation, salad, soup, steak, pasta, drinks. Since the time stamp information includes start and finish of each meal, the user can learn whether meals are being eaten too rapidly, or too frequently, etc. Calorie counting according to the above described embodiment is transparent, automatic, and in general more accurate than the typical hit or miss writing down of guestimated calories for some meals.

The embodiment of FIG. 5B also promotes the health of user 20 and can keep accurate record of the user's exercise regimes on equipment 45, here shown generically as a treadmill. Again three-dimensional images acquired enable system 100′ to uniquely identify each user, for whom there will have been pre-stored in a user profile, e.g., in memory 200, user ID, user weight, user age, etc. In practice, upon identifying user 30 via imaging, system 100′ preferably enables exercise device 45 to automatically adjust itself to a preferred setting for this user.

Thus, user 20 simply approaches exercise device 45, and begins to use the custom-adjusted device. As the user exercises on equipment 45, system 100′ automatically tracks how long the exercise session lasted. In some embodiments, system 100′ can quantize from acquired images whether the workout was hard, easy, or in-between. In other embodiments, electronic and/or mechanical feedback signals from equipment 45 can be coupled (via wire, wirelessly, etc.) to system 100′ to provide an exact measure of the nature of the workout, e.g., 20 minutes at 4 mph at 30% incline, followed by 18 minutes at 4.5 mph at 35% incline, etc. In this fashion, for each type of exercise equipment 45, e.g., treadmill, stationary bike, weight lifting machine, etc., system 100′ maintains a time-stamped log of each user's exercise regime for each day.

Using simple equations, software in memory 200 can estimate calories burned on a per user basis, since the user's age, weight, etc. is known. The log data can be coupled to PC appliance 30-2 and reviewed by the user user's health care provider, and can also be shared with others, including sharing over the Internet, perhaps with a virtual exercise group. In this fashion user 20 is encouraged to compete, albeit virtually, with others, and will generally be more likely to stick to an exercise plan. Further, the user is encouraged to finding exercise partners and/or trainers, real and virtual, via the Internet. In addition, as the user is encouraged to try different exercise machines, different exercise positions;;; and regimes, the user can better see what combinations work best in terms of providing a good workout and burned off calories.

Many health conscious users Yoga or other exercise in which it is desired to attain and maintain certain body positions. Yet without having a workout partner to observe and offer corrections to a user's body positions during Yoga (or the like), it can be difficult for a user to know when proper positions have been attained, or for how long such positions are properly maintained. Referring again to FIG. 5B, let reference numeral 45 now denote an exercise pad or area upon Yoga or other exercise is practiced by user 20 performs exercise, In this embodiment system 100′ can automatically view the user's exercise and ascertain uniquely to the user, based upon user profile data stored in memory 200, whether proper positions are attained. System 100′ can automatically collect time-stamped images and data memorializing histories of attained and maintained Yoga or other positions. Appliance 30-2 may be a computer with memory storing images of bona fide proper Yoga positions for user 20. As the user practices Yoga movements, system 100′ captures the attained positions and appliance 30-2 can compare these images to images representing good Yoga positions. Software within computer 30-2 can grade the quality, duration, repetition of the user's Yoga exercise, and degree of success of the exercise, and thus provide customized feedback as a learning tool. Further acquired images can be shared, in person or via the Internet, with an instructor for additional feedback as to positions attained, and so forth.

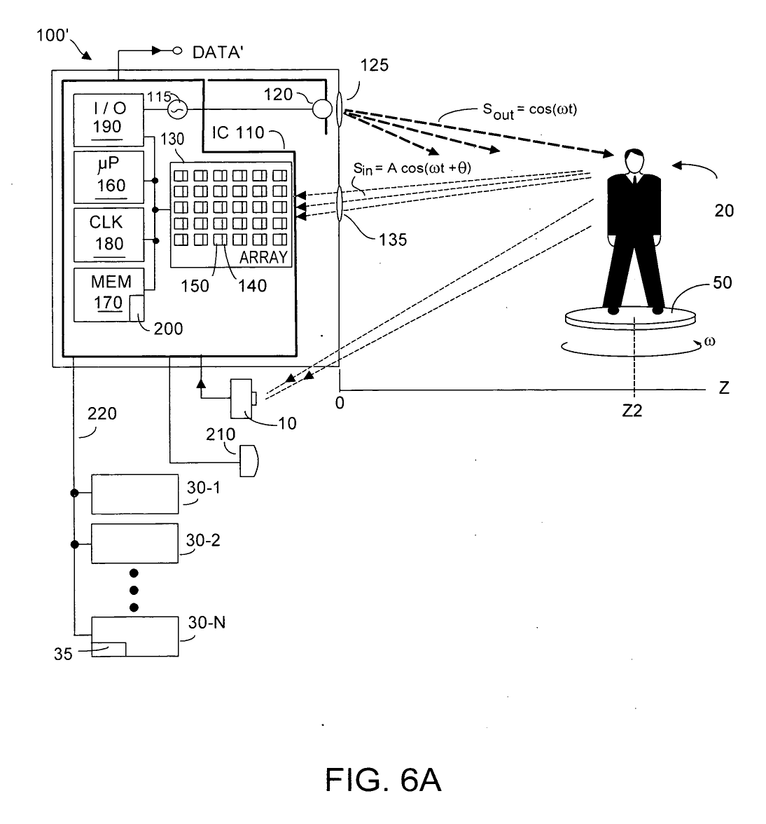

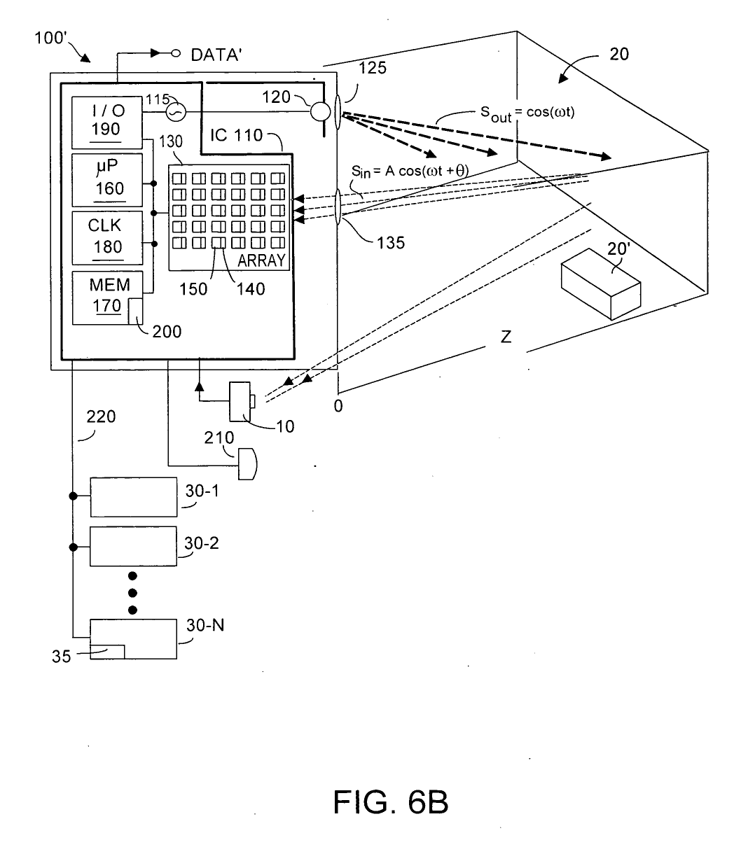

FIG. 6A depicts system 100′ used to remotely acquire metric data from an object, here user 20, without physically contacting the object. In one embodiment, the system of FIG. 6A facilitates the rapid taking of user measurements, perhaps to custom make clothing and the like for a user. Traditionally custom making a shirt or pants or suit or the like would require many careful measurements of various regions of the user's body. Taking these measurements requires physical contact with the use, and calls for the skill of a tailor. Further these time measurements are time consuming, and can result in measurement error, and in transposition error in writing down or otherwise memorializing the measurements. Rather than gather such data manually, as has been done for centuries, the configuration of FIG. 6A enables system 100′ to automatically acquire all measurement data remotely from the user, in a relatively short time, without need for skilled labor. In other applications, it may not be feasible to get close to the object to take manual measurements. For example the object may be located in a dangerous environment, perhaps high off the ground, or in a radioactive environment.

In FIG. 6A, the object to be measured, here user 20, is placed on a slowly rotatable surface 50, to enable three-dimensional system 100′ to acquire depth images from all orientations relative to an axis of rotation, shown in phantom. The distance Z2 from TOF system 100′ to the axis of rotation is know a priori, and acquired depth data can be carefully calibrated to actual measurements, e.g., if the width of user 20 is say 25″, the width of the acquired depth image can be accurately scaled to be 25″. In this fashion, all measurement data traditionally taken by a tailor or tailor's assistant can be acquired automatically, without error, in perhaps a minute or so. This data can be communicated to a PC appliance 30-x, or the like, which can broadcast the data wirelessly or otherwise or perhaps via a telephone line (not shown) or Internet to a customized tailor shop.

Given the acquired dimensions, the tailor shop can readily create the desired articles of clothing for user 20. In this fashion, clothing for user 20 can be customized, even if user 20 has somewhat exotic dimensions. It is understood that the term “clothing” may also encompass shoes, in which case the user's bare or stocking feet would be imaged. PC 30-X may include in its memory a routine 35 that upon execution, e.g., by the computer's processor (not shown) can “age” the dimensions for subsequent use. For example, if three years later the same user wishes another suit made but has increased body weight by 10% from the time of the measurement, the original measurements can be aged or scaled to reflect the user's current girth, etc. In another example, user 20 might have been a ten year old boy who is now age twelve. Again the original data acquired by system 100′ could be scaled up, e.g., by software 35, to render new measurement data suitable for a tailor. Such scaling may be necessary when it is not possible for the user to again be measured with a system 100′.

Understandably object 20 in FIG. 6A might be a radioactive object whose measurements are required. System 100′ can acquire the measurement data because no physical contact (aside from reflected optical energy) is required with the object. In some applications it may be necessary to move system 100′ relative to object 20, or to acquire less than full 360° imaging.

FIG. 6B depicts an embodiment in which system 100′ is used to acquire three-dimensional images of a room 20 and object(s) 20′ within the room. The acquired images can yield accurately scaled dimensions for the room and objects, and have many uses. For example, an architect who proposes to remodel a room or rooms can acquire accurate depth images and then experiment, for example, by resealing perhaps to decrease the width of one room while expanding the width of an adjacent room. Such resealing would provide a virtual model of what the rooms might look like if the common wall were relocated. More mundane uses of the acquired images could include accurate estimates of new sheetrock or wallpaper or paint needed to cover wall and/or ceiling surfaces, accurate estimates for floor covering, etc.

An interior decorator might wish to experiment by rescaling acquired images of furniture within an image of the room, or perhaps placing virtual images of other furniture within the room image, to enable the homeowner to see what a given sofa might look like against one wall or another. Thus embodiments such as shown in FIG. 6B enable virtual remodeling of rooms in a living or work space, in addition to providing accurate data for purposes of estimating building or painting or floor covering material. In other applications, the acquired imagery might be melded into a virtual reality space or game, perhaps as viewed on TV appliance 30-2. A user could virtually walk through a three-dimensional image space representing a real room, perhaps to search for treasure or clues hidden within the virtual space.

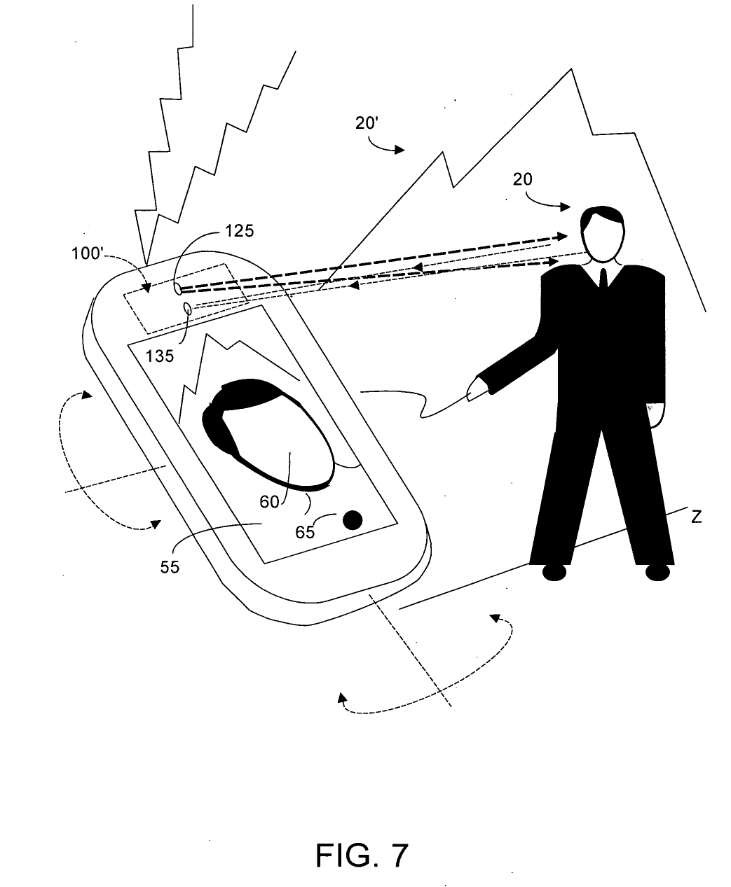

FIG. 7 depicts an embodiment of the present invention in which the TOF components comprising system 100′, e.g., IC 110 as shown in FIG. 4, which includes array 130, and components 115, 160, 170, 180, 190, as well as emitter 120, and lenses 125, 130 are disposed within an appliance (where “within” is understood to include disposing system 100′ “on” the appliance instead of inside the appliance), here a cell telephone with video camera, or a standalone still and/or video camera 55. As described in the cited Canesta, Inc. patents, implementation of system 100′ preferably is in CMOS and can consume relatively low power and be battery operated. In FIG. 7, user 20 is holding appliance 55, which for ease of illustration is drawn greatly enlarged and spaced apart from the user's right hand. Behind user 20 is background imagery, here shown generically as a mountain range 20′. The screen of device 55 shows the user's head 60 as well as a portion of the background image.

Assume that user 20 is conducting a video conference in which device 55 images the user's head, and assume further that the user's right arm is not particularly stable or that perhaps the user is walking while video conferencing. In either event, one undesirable outcome is that other participants in the video conference will see a jittery image acquired by device 55, due to device vibration. The video image transmitted by device 55 is represented by the zig-zag lines emanating from the top of the device. In one embodiment of the present invention, the video signals transmitted to the conference participants is stabilized through use of three-dimensional images acquired by system 100′.

The three-dimensional image can discern the user's face as well as the background image. As such, system 100′ can determine by what amount the camera translates or rotates due to user vibration, which translation or rotation movement is shown by curved phantom lines with arrow heads. Software 200 within system 100′ upon execution, e.g., by processor 160, can compensate for such camera motion and generate corrective signals for use by the RGB video camera within device 55. These corrective signals act to de-jitter the RGB image captured by the camera device 55, reducing jerky movements of the image of the user's head. The result is to thus stabilize the RGB image that will be seen by the other video conference participants. Advantageously such image stabilization can be implemented using an array 130 having relatively low pixel density.

In another embodiment, system 100′ can be used to subtract out the background image 20′ from the acquired image of user 20. This is accomplished by using the Z or three-dimensional depth image to identify those portions of depth images that are the user, and those portions of the depth image that have Z depth greater than the farthest Z value for the user. In the example of FIG. 7, assume that the user holds camera 55 one foot away from the user's head. System 100′ can readily determine that relevant values of Z for the user's image are in the range of about one foot, e.g., slightly less for the tip of the user's nose, which is closer to system 100′ and a bit more for the user's ears, which are further away.

Thus portions of the depth image having Z values greater than say the Z value representing the user's ears are defined as background because these portions literally are in the background of the user. This data is then used in conjunction with the RGB data acquired by camera 55, and those portions of the RGB image that map to image regions defined by system 100′ as background can be subtracted out electronically. The result can be a neutral background, perhaps all white, or a pre-stored background, perhaps an image of leather covered books in an oak bookcase. This ability of the present invention to use a combination of depth and RGB data enables background substitution, akin to what one often sees on television during a weather report in which a map is electronically positioned behind the weather person. However the present invention accomplishes background substation without recourse to blue or green screen technology as is used in television and film studies.

In yet another embodiment, the configuration of FIG. 7 can be used to allow camera device 55 to function quasi-haptically as though it contained direction sensors. Such functionality enables user 20 to use camera device 55 to play a video game displayed on the camera's screen. Assume that a Pac-Man type labyrinth is represented by 60 on the camera screen, and that a movable “marble” is present, depicted as 65. As the user tilts the camera from a horizontal plane, e.g., the camera display screen plane is horizontal, the virtual marble will appear to move. The challenge is for the user to manipulate camera 55 to controllably maneuver the marble within the labyrinth displayed on the camera screen.

Rather than translate user movements of camera 55 using mechanical motion and direction sensors, e.g., gyroscopes, accelerometers, etc., the present invention acquires three-dimensional depth images using system 100′, for example of the user's face, as the camera is moved. These images enable software 200 to determine the current dynamic orientation of the image plane of camera 55, e.g., the plane of the camera image display, relative to the horizontal. Thus if the user tips the head of the camera slightly downward, marble 65 will appear to roll toward the upper portion of the display screen. The direction and amount of tilt is determined by system 100′, which instantly senses that the Z distances to regions of the user's face have just changed. This embodiment could also emulate an electronic plane, in the same fashion.

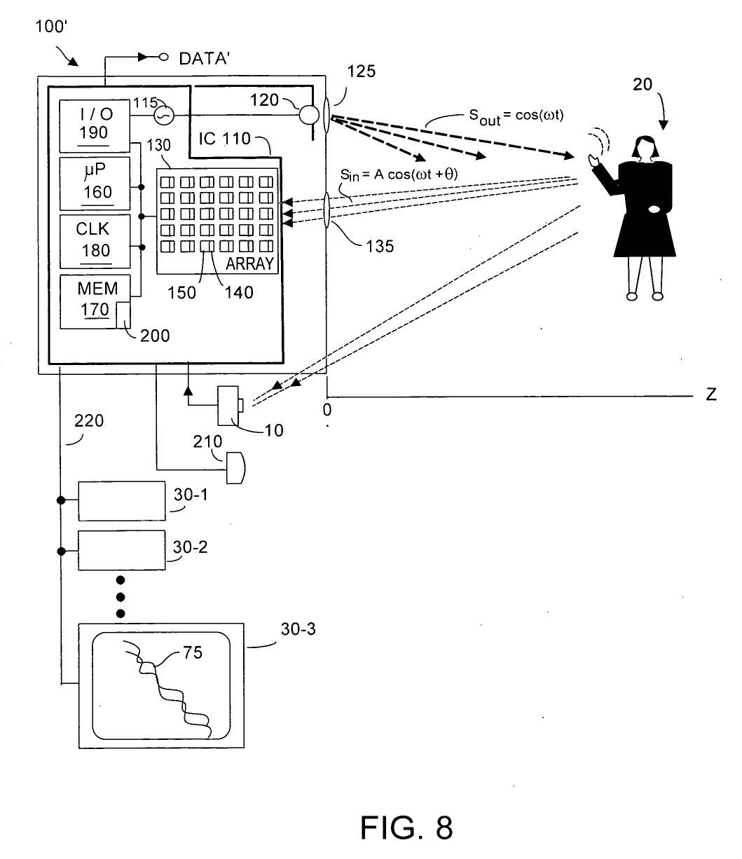

Turning now to FIG. 8, system 100′ stores in three-dimensional model data for objects in memory 200, or has access to such data stored externally to system 100′. An RGB or grayscale image of the three-dimensional model is presented as 75 on display 30-3. User 20 can view this display and directly manipulate the three-dimensional model in space by virtually moving it with the user's finger(s) and hand(s). As the user's hand(s) are moved in space within the field of view of system 100′, three-dimensional images are acquired. Within system 100′, if not processed off-system 100′, a mapping can relate changes of the user's hand(s) in three-dimensional space with desired movement of the virtual object in three-dimensional space. For example, in FIG. 8, a model of a DNA strand is shown. User 20 can virtually move, rotate, translate, and otherwise directly manipulate this model in three-dimensional space. Such applications are especially useful in science, and the manipulated virtual model could of course be broadcast substantially in real-time to others via a network, the Internet, etc., perhaps for use in a video conference. If desired, the model might be of a child's Lego™ building blocks. User 20 could view these blocks on display 30-3 and directly manipulate them in three-dimensional space, for example to build a virtual wall, a virtual castle, etc. If desired the resultant virtual construction could then be printed, emailed, etc. for further enjoyment by others.

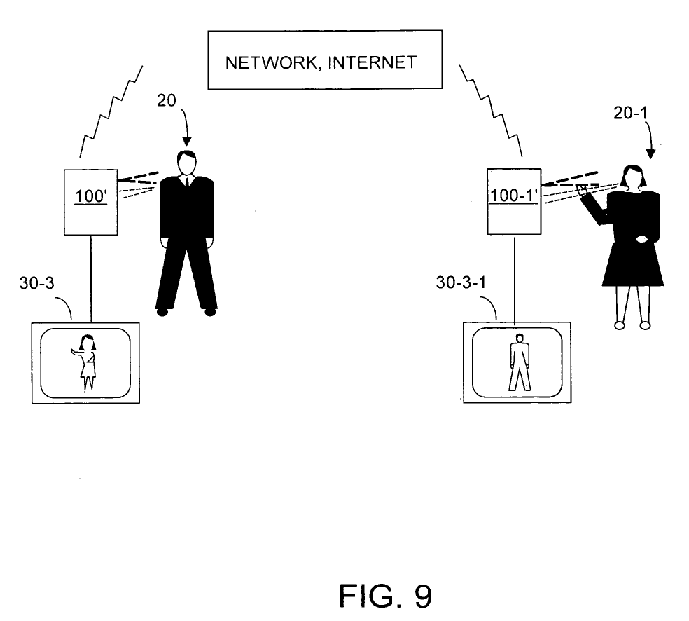

FIG. 9 depicts yet another aspect of the present invention. As noted earlier herein, system 100′ acquires three-dimensional images of users within the system's field of view. Prodessor 160 within system 100′, of an externally located processor, can digitize the acquired images and generate cartoon-like three-dimensional puppet or avatar representations of the user. The user's actual facial expression, e.g., smile, frown, anger, can also be represented on the avatar, which avatar can move in three-dimensions as the user moves. This technique of recording user movement in three-dimensional space and translating the movement into a digital model is sometimes referred to as motion capture.

In FIG. 9, two three-dimensional systems 100′, 100-1′, are shown at different locations, imaging respective user(s) 20 and 20-1. The three-dimensional systems preferably broadcast the avatar model data, perhaps via a network or the Internet, to other users. In this embodiment, user 20 can see displayed on his appliance 30-3 an avatar representation of female user 20-1. Similarly, user 20-1 can see displayed on her appliance 30-3-1 an avatar of male user 20. These avatars will move as their human counterparts move, e.g., if user 20-1 waves her right arm, user 20 will see that avatar on appliance 30-3 move its right arm correspondingly. If user 20-1 frowns, the avatar shown on device 30-3 will frown, and so forth. Of course user 20-1 will see on the avatar displayed on her device 30-3-1 movements and facial expressions corresponding to what user 20 is doing at the moment.

Human users 20 and 20-1 might compete in a virtual game of handball, and can see on their respective appliances 30-3, 30-3-1, the game being played, and where the virtual handball is at the moment. If user 20 sees that the avatar on device 30-3 has just hit handball to the far left corner of the virtual handball court, user 20 will reposition his body and then swing his real arm to directly manipulate his virtual arm on his avatar and thus return the virtual handball to his opponent. In other applications, one or more users may participate in a virtual world such as Second Life. Thus user 20 can view events and objects in this virtual world on his device 30-3 and cause his avatar to do whatever he wishes to do. One could of course use avatar representations in a video conference, if desired. Other applications are of course possible.

Modifications and variations may be made to the disclosed embodiments without departing from the subject and spirit of the present invention as defined by the following claims. Although preferred embodiments have been described with respect to use of a three-dimensional TOF imaging system, as has been noted, other three-dimensional imaging systems could instead be used. Thus the notation 100′, while preferably referring to a true TOF three-dimensional imaging system, can be understood to encompass any other type of three-dimensional imaging system as well.

What is claimed is:

1. A method for a user to interface with at least one appliance, the method comprising the following steps:
(a) storing in a system a library of user profile data representing at least one potential user;
(b) capturing three-dimensional image data of a user in a space within which said appliance is desired to be operative;
(c) comparing data captured at step (b) with data stored in step (a) to identify said user and a profile for said user; and
(d) causing said device to activate in a manner according to said profile for said user.

2. The method of claim 1, wherein step (b) is carried out using a time-of-flight imaging system.

3. The method of claim 1, wherein at step (b), said appliance includes at least one appliance selected from a group consisting of (i) an entertainment appliance, (ii) a message-capturing appliance, (iii) a security appliance, (iv) an air-conditioning appliance, and (v) a space heating appliance.

4. The method of claim 1, wherein step (d) activates said appliance as a function of at least one of current date and current time.

5. The method of claim 1, wherein said appliance is a television, and:
step (a) includes storing a database of television programming data representing programs viewable on said television as a function of time; and
step (d) includes said system commanding said television to turn-on to a specific channel in accordance with said user profile.

6. The method of claim 5, further including:
using said system to capture three-dimensional data identifying each user watching said television, as a function of date and time; and
generating data representing a log of which users view what programming on said television at what dates and at what times.

7. The method of claim 6, further including communicating generated said data representing a log to at least one of a producer of television programming, a sponsor who has commercials viewable on said television, and a producer of film making.

8. The method of claim 1, wherein data captured at step (b) for a user is used as biometric identification limiting access to at least one appliance selected from a group consisting of (i) an answering machine, (ii) a computer account, (iii) a computer file, and (iv) financial data.

9. A method to enhance performance of an RGB image captured by a user appliance that includes a camera, the method comprising:
(a) providing said appliance with a system that captures three-dimensional image data of at least one object within a relevant field of view for said appliance;
(b) using three-dimensional image data captured at step (a) to reduce effects from any jitter in at least one RGB image acquired by said appliance;
(c) causing said appliance to output at least one RGB image corrected at step (b);
wherein effects of jitter in an RGB image output by said appliance is reduced.

10. The method of claim 9, wherein said appliance is at least one of (i) a camera within a mobile phone, (ii) a stand-alone still camera, and (iii) a video camera.

11. The method of claim 9, wherein step (a) includes providing a time-of-flight system.

12. The method of claim 9, wherein said appliance includes a user visible display of an image acquired by said appliance, and:
step (b) uses three-dimensional image data captured at step to determine orientation of a plane of said camera;
said system further displays a video game on said display including a displayed virtual object that moves virtually as a function of changes in orientation of said plane of said camera;
wherein said camera is caused to act quasi-haptically by allowing a user to control position of said displayed virtual object as said user alters orientation of said camera such that a video game can be played using said camera.

13. A method enabling movement of a displayable virtual object as a function of movement of at least part of a first user, the method comprising the following steps:
(a) providing a first system to capture three-dimensional image data of at least a portion of said first user;
(b) providing a first display whereon is viewable at least one of (i) a display of a virtual object, and (ii) a display of second user;
(c) using data captured at step (a) to allow said first user to directly manipulate said virtual object displayed on said first display.

14. The method of claim 13, wherein at step (b) said virtual object includes at least one of (i) a molecule, and (ii) a DNA strand.

15. The method of claim 13, wherein step (a) includes providing a time-of-flight system.

16. The method of claim 13, wherein data captured at step (a) is used to create a dynamic avatar representation of said first user, said avatar transmittable for viewing on at least a second display.

17. The method of claim 13, further including at least a second system to capture three-dimensional image data of at least a portion of a second user, said second system creating a dynamic avatar representation of said second user, said dynamic avatar created by said second system being transmittable for viewing on at least said first display.

18. The method of claim 17, wherein each avatar is transmittable via at least one of a network and the Internet.

19. The method of claim 17, wherein said first system and said second system enable said first user and said second user to interact with each other.

20. The method of claim 17, wherein said first system enables said first user to interact with a virtual reality world.
